(19) United States
(12) Patent Application Publication
(10) Pub. No.: US 2003/0149786 A1
(43) Pub. Date: Aug. 7, 2003

(54) Efficient counter retrieval

(76) Inventors: Mark Duffy, Lexington, MA (US); Robin Iddon, Edinburgh (GB); Andi Abes, Billerica, MA (US)

Correspondence Address: FISH & RICHARDSON PC, 225 FRANKLIN ST, BOSTON, MA, 02110, US

(21) Appl. No.: 10/068,147

(22) Filed: Feb. 6, 2002

(51) Int. Cl. G06F 15/173; G06F 15/16

(52) U.S. Cl. 709/235; 709/224

(57) ABSTRACT

A method and system include collecting information in a network device, determining in the network device when to send a subset of the collected information to a collection system, and determining in the network device a subset of the collected information to be transmitted at a given time.

### FIELD OF THE INVENTION

This invention relates to network counter retrieval.

### BACKGROUND

Typically, in network systems, there are many ways in which network measurements such as usage, delay, variation of delay, packet loss, and the like, can be carried out. In particular, packet-oriented telecommunications network devices typically maintain statistical counters regarding many aspects of network operation. For instance, these statistics are useful for billing, network troubleshooting, network engineering, and trend analysis. Generally, statistics are retrieved from a device to yield relevant data. The retrieval of information typically occurs across the network using a variety of communications protocols, e.g., Simple Network Management Protocol (SNMP) running over the Internet Protocol (IP).

In some instances, statistics need to be retrieved only under certain circumstances (e.g., statistics used for network troubleshooting). Such statistical information only needs to be retrieved and examined when there are network problems. Other types of statistics need to be retrieved on a regular and continuing basis. For example, statistics pertaining to billing may need to be retrieved frequently and periodically.

### SUMMARY

According to one aspect of the invention, a method and system include collecting information in a network device, determining in the network device when to send a subset of the collected information to a collection system, and determining in the network device which subset of the collected information to send at a given time.

One or more of the following features may also be included. Information is collected according to a configured periodicity. Information consists of statistical values stored in counters.

As another feature, the subset is a value of a counter and can also represent values of multiple counters.

In certain embodiments, determining when to send a subset is user-configurable. In certain embodiments, determining when to send it is done autonomously by a network device. In either case, the determination can include determining a low peak period of a network operation and/or of the network device's own operation, and sending the subset during the low peak period.

As yet another feature, the method includes associating each unit of the collected information with an identifier. The method also includes the option for using locally significant tags as identifiers for greater efficiency. The method further features associating the locally significant value of the tag with a globally significant identifier value, and expressing that association through a communications channel of a computer network system.

As another feature, the information of the statistical value that is unchanged is not transmitted from the network device to the collection system.

The method further includes sending acknowledgements from the collection system to the network device with respect to receipt of the collected information by the collection system. In addition, the collected information is reported at least once within a set time interval.

According to another aspect of the invention, a system includes a collection system coupled to a network device through a communications channel of a computer network system, and a network device configured to determine when to send a subset of the collected information to a collection system and to determine in the network device which subset of the collected information to send at a given time.

One or more of the following features may also be included.

The network device is configured to determine a periodicity for sending all collected information.

The collected information consists of statistical values stored in counters. The subset is a value of a counter or the values of multiple counters.

In certain embodiments, the network device being configurable as to when to send a subset of the collected information, and in certain embodiments the network device determining autonomously when to send a subset of the collected information.

As another feature, the network device determination as to when to send includes the network device determining a low peak period of a network operation, and/or a low peak period of the network device's own operation, and sending the subset during the low peak period.

Embodiments may have any of the following advantages.

The collection system receives the needed information without having to poll the network devices, which increases the scalability for periodically retrieving counters when counter instances become large, number of network devices becomes large, or both. It is possible to obtain periodic collection of large numbers of data elements from a large number of network devices, while maintaining a high level of real-time responsiveness characteristic of polled solutions without the drawbacks of a polled approach. Thus, the present methods and systems retain the real-time responsiveness of a polled approach while removing the scalability concerns of polling data from each individual network device.

The excessive network bandwidth and network device capacity consumed by polling individual counters is eliminated. Such drain on network resources is avoided because the need for requesting, locating and transmitting specific counter instances on demand is eliminated.

Efficiency is significantly enhanced by providing data aggregation (by the subsets of the collected information sent) and aggregated acknowledgements, as well as by allowing suppression of counters having unchanged values. Furthermore the network device is able to transfer collected information in a sequence convenient to it (such as the sequence in which the information is stored in an internal array) and to schedule the transmission of data at points in time which are convenient and appropriate to the network device.

### DESCRIPTION OF DRAWINGS

FIG. 1 is a block diagram of a network.

FIG. 2 is a flow diagram of a counter retrieval system.

FIG. 3 is a diagram of an array.

### DETAILED DESCRIPTION

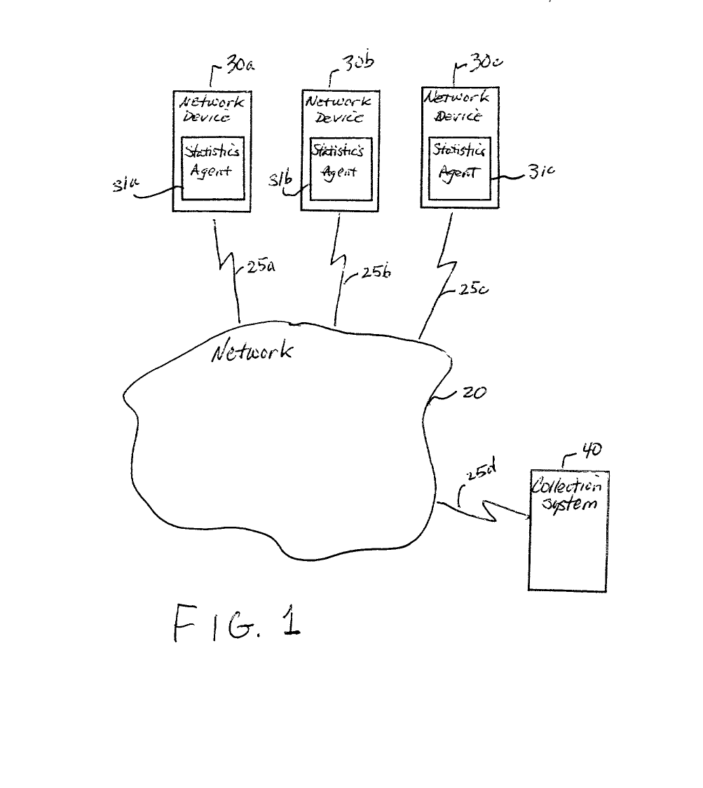

Referring to FIG. 1, a network counter system 10 includes a group of globally connected computer systems within a computer network 20 such as the Internet, three network devices (e.g., Internet Protocol (IP) service switches 30a-30c) connected through the network 20 to a collection system 40 such as a billing statistics collection system using communications channels 25a-25d.

The computer network 20 is a TCP/IP network that carries voice, data, or both. The computer network 20 includes a number of nodes (not shown) interconnected by communications paths and communications channels. The computer network 20 can interconnect with additional networks and include subnetworks. In particular, the IP service switches 30a-30c are linked to the computer network 20 via communications channels 25a-25c, respectively. The collection system 40 is linked to the computer network 20 via the communications channel 25d.

In this example, the IP service switches 30a-30c are used to provide access to the computer network 20, as well as associated Quality of Service (QoS) and security services, for various subscribers (not shown). Each of the IP service switches 30a-30c includes a general central processing unit (CPU) system and other hardware implementing various networking protocol functions, for example, those of the Transport Control Protocol/Internet Protocol (TCP/IP) suite, with associated management and control features. Each of the IP service switches 30a-30c includes statistics agent modules 31a-31c. The statistics agent modules 31a-31c are implemented to report over the computer network 20 statistical information about the IP service switches 30a-30c through their respective communications channels 25a-25c. The statistics agent modules 31a-31c are implemented in hardware, such as with an application-specific integrated circuit (ASIC), or in software, or in a combination of hardware and software.

For example, each of the IP service switches 30a-30c provides billable IP-based services to a network operator's subscribers. The IP service switches 30a-30c can provide traffic statistics kept on a per-subscriber basis within the IP service switches 30a-30c in support of usage based billing. The IP service switches 30a-30c can support many tens of thousands of subscribers and manage scores of data items (e.g. service usage statistical counters) for each subscriber. The IP service switches 30a-30c are real-time network devices whose primary functions are the processing of data packets, that processing including forwarding and application of IP services to the packets. Although there are other tasks to be accomplished in the IP service switches 30a-30c in support of data packet processing, those tasks have various levels of urgency. The reporting of statistics and related tasks can have lower urgency and therefore lower processing priority relative to most other software or hardware functions.

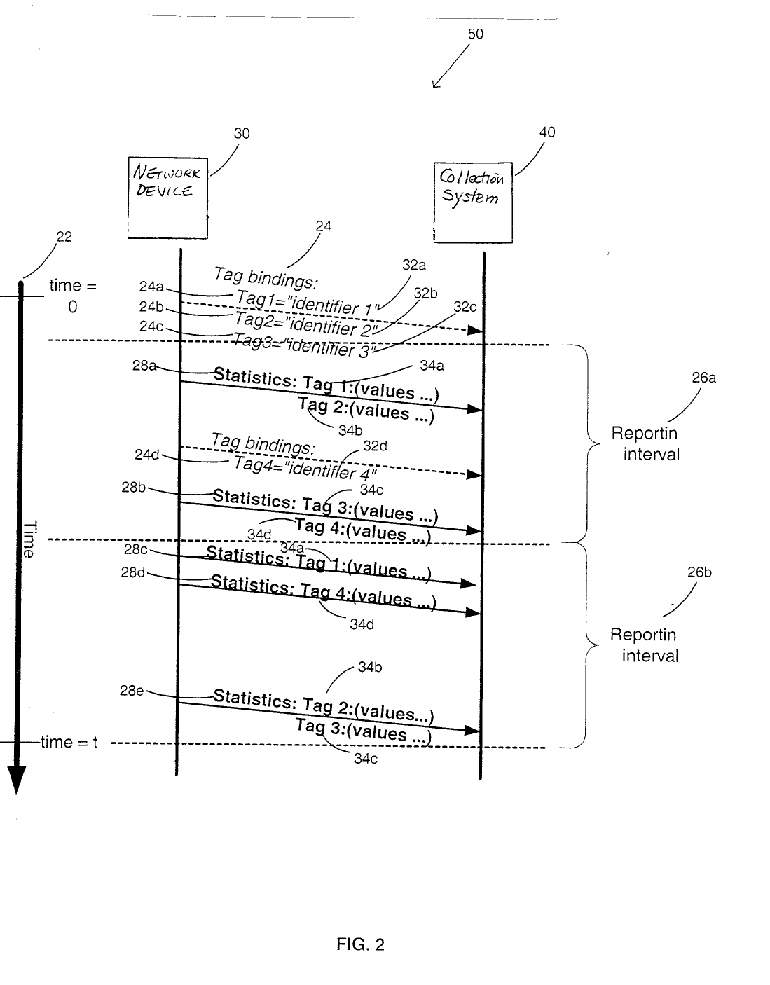

Referring to FIG. 2, statistical data 28 is collected across the computer network 20 of FIG. 1 from the IP service switch 30. The collection system 40 collects statistical data 28 from an IP service switch 30 in a reporting process 50 as time line 22 progresses from a time “0” to a time “t”. The collection system 40 processes the statistical data 28 for such uses as subscriber billing.

In the reporting process 50, the IP service switch 30 periodically sends statistical data identified by tag bindings 24, in any order the IP service switch 30 deems appropriate, to the collection system 40. In particular, the IP service switch 30 forwards statistical data 28 to the collection system 40 at its convenience during periods of time where the computer network 20 has low network usage, i.e., low levels of data traffic or the IP service switch 30 has low CPU usage. The IP service switch 30 also reports statistical data 28 in an order efficient for the IP service switch 30, for example, in the order that the data items have been stored in an internal memory or buffer of the IP service switch 30, thereby avoiding CPU intensive lookups for specific statistical data.

In operation, at time =0, the IP service switch 30 transmits tag bindings 24a-24c to the collection system 40. Other tag bindings 24d may be sent later as they are defined in the IP service switch 30. The tag bindings 24 announce associations between locally significant tags, and globally significant identifiers of specific data items such as a statistical counter. More specifically, each tag binding, such as tag binding 24a, associates a tag value (e.g. Tag1) with a globally significant identifier value (e.g., “Identifier 1”). The identifier value can be of any data type that identifies the collected data item of interest. For example, for billing purposes, a company name such as “Acme Corporation,” can serve as the identifying name of an entity for which the billing data is being reported to the collection system 40. Therefore, identifier values (e.g., “Identifier 1, Identifier 2, Identifier 3, and Identifier 4”), represent globally significant identifiers 32a-32d. Such globally significant identifiers 32a -32d are recognized by the network counter system 10 and can be processed by the collection system 40, the IP service switch 30, and any other network node or switch that make up the network counter system 10. Moreover, the locally significant tags 24a-24d (Tag1, Tag2, Tag3, and Tag4) are bound to and associated with the identifier values 32a-32d. The bound tags 24a-24d are valid for a period of time, and various components of the network counter system 10 can use the bound tags 24a-24d as convenient aliases for the identifiers 32a-32d.

Using the same communications channels 25a-25d used to transmit tag bindings 24 as described above, at a time=t, where t is greater than 0, the IP service switch 30 sends statistical data 28 logically associated with the previously transmitted tag bindings 24. In other words, rather than sending statistical data 28 with the globally significant identifiers 32a-32d, the IP service switch 30 sends statistical data 28 with locally significant identifiers 34a-34d. The locally significant identifiers 34a-34d, with values Tag1, Tag2, Tag3, and Tag4, are used by the collection system 40 to identify the accompanying counter or statistical data 28.

For example, when the IP service switch 30 sends statistical data 28a, the IP service switch 30 is transmitting locally significant identifiers 34a-34b with values Tag1 and Tag2, respectively. The collection system 40, in turn, upon receiving the locally significant identifiers 34a-34b, determines which globally significant identifiers 32a-32b correspond to the data items (counter values) sent in statistical data 28a. That is, by receiving only the locally significant identifiers Tag1 and Tag2, the collection system 40 is able to computationally resolve that it is the statistical counters for “Identifier 1” and “Identifier 2” that the collection system 40 has received, because the tag bindings 24a-24b have already been received by the collection system 40 earlier in the reporting process 50.

The logical association between the locally significant identifiers 34a-34d and the globally significant identifiers 32a-32d is made available to the collection system 40. This may be done synchronously within the same communications channel 25 that the statistical data 28 are reported through, thus allowing temporal reuse of the locally significant tags 34a-34d without introducing ambiguities as to their current association with globally significant identifiers 32a-32d.

Rather than tagging the statistical data 28 with the globally significant identifiers 32a-32b, locally significant identifiers are used to identify the statistical data 28 as they are sent to the collection system 40. This reduces bandwidth consumed at the computer network 20 through the communications channel 25, since the locally significant identifiers are more compact than the globally meaningful identifiers. Moreover, locally significant identifiers that correspond to array indices can be used, avoiding complex lookups.

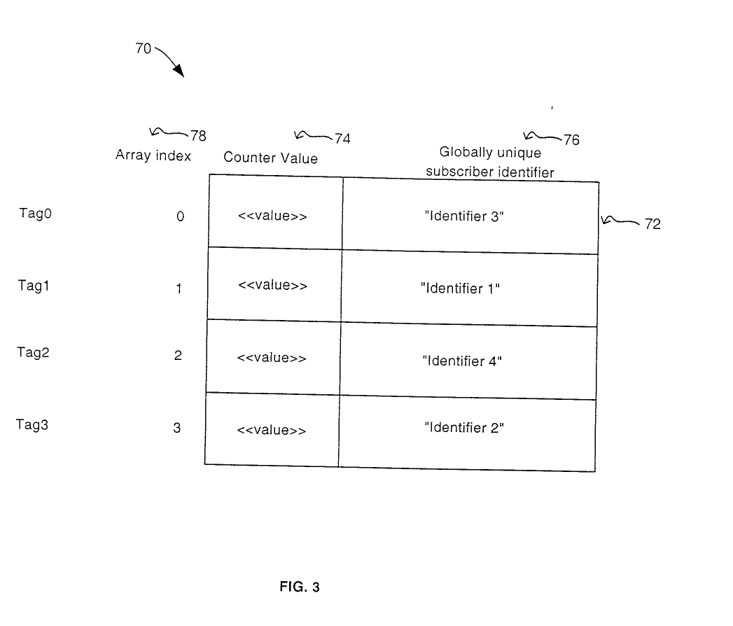

Referring to FIG. 3 the IP service switch 30 stores the statistical counters in a data structure such as an array 70. Each row 72 of the array 70 contains a counter value 74 for a particular subscriber, for example. FIG. 3 illustrates one statistical counter 74 kept per subscriber, although more are present. The array 70 also stores the subscriber name 76 corresponding to each row 72 of the array 70, which in this example is the globally significant identifier 32. Since the IP service switch 30 assigns the values of the locally significant tags 34, the IP service switch 30 arranges the assignment so that an array index 78 corresponding to a particular subscriber is assigned as the local tag 34 for the statistical data of the subscriber. Since the network counter system 10 allows the IP service switch 30 to transmit collected data subsets in any order, the IP service switch 30 sends the counter values 74 in the order they are stored in the array 70, tagging each counter value 74 with the associated array index 78.

Referring back to FIG. 2, the tag bindings 24 are sent before statistical data 28 using those particular bindings are sent. Thus, before the data identified by a new globally significant identifier code 32d, namely “Identifier 4,” is sent to the collection system 40, the new identifier code is first bound to a local tag 24d (e.g., Tag4). Thereafter, statistical data 28b tagged with the locally significant tag 34d is sent to the collection system 40. Similarly, statistical data 28c-28e tagged with the locally significant tags 34a-c may be sent to the collection system 40 because the tag bindings 24a-24c have been sent previously to the collection system 40.

In the reporting process 50, the IP service switch 30 transmits statistical data 28 to the collection system 40 in sequence and at specific points in time which are efficient and convenient for the IP service switch 30 (e.g., idle periods for the IP service switch 30 or low peak usage periods for the network 20 or the communication channels 25). In particular, the IP service switch 30 reports statistical data 28 during reporting intervals 26a-26b. The IP service switch 30 reports every statistical data 28 at least once per reporting interval 26. Thus, during a reporting interval 26a, the IP service switch 30 reports statistical data 28 for locally significant identifiers 34a-34d, and during a reporting interval 26b, the IP service switch 30 again reports statistical data 28 using the same locally significant identifiers 34a-34d used in the previous reporting interval 26a. For example, at least once per hour, or once during any predetermined period of time, all statistical data 28 can be reported to the collection system 40 without polling the IP service switch 30.

In certain situations, the statistical data 28 may not have advanced or incremented, that is, the statistical data 28 has not been changed since the last reporting. In these cases, the IP service switch 30 refrains from transmitting the statistical data 28. The collection system 40 can assume the incremental counts are zero unless the IP service switch 30 reports otherwise.

In the example described above in conjunction with FIGS. 1, 2, and 3, the reporting process 50 between the IP service switch 30 and the collection system 40 may be preceded by an associated signaling phase where the IP service switch 30 and the collection system 40 authenticate each other, may establish a secure channel of communications, may communicate agreements on general parameters of any further and subsequent transfers of data, and the like.

The IP service switch 30 may also be used for collecting other types of statistical counters, such as network troubleshooting counters. The reporting process 50 may be applied to the collection of data other than statistical counters, such as event logging records. Moreover, the collection system 40 may transmit acknowledgements (e.g., ACK packets) to the IP service switches 30a-30c to support a reliable network delivery system.

Other embodiments are within the scope of the following claims.

What is claimed is:

1. A method comprising:
collecting information in a network device;
determining in the network device when to transmit a subset of the collected information to a collection system; and
determining in the network device the subset of the collected information to be transmitted at a given time.

2. The method of claim 1 in which the collected information comprises values stored in counters.

3. The method of claim 1 in which the subset represents a value of a counter.

4. The method of claim 1 in which the subset represents values of multiple counters.

5. The method of claim 1 in which determining when to send is user-configurable.

6. The method of claim 1 in which determining when to send comprises:
determining a low peak period of a network operation; and
sending the subset during the low peak period.

7. The method of claim 1 further comprising tagging the value of the collected information with an identifier.

8. The method of claim 7 further comprising using a locally significant tag value as the identifier.

9. The method of claim 8 wherein the locally significant tag value is an array index.

10. The method of claim 9 further comprising associating the locally significant value of the tag with the globally significant value of the identifier and announcing the association through a communications channel of a computer network system.

11. The method of claim 10 in which a communication channel used to announce tag and identifier associations is the channel used to transmit collected information.

12. The method of claim 1 in which the collected information that is unchanged is not transmitted from the network device to the collection system.

13. The method of claim 1 further comprising sending acknowledgements from the collection system to the network device when the collection system receives the collected information.

14. The method of claim 1 in which the collected information is reported periodically.

15. The method of claim 1 further comprising establishing a signaling phase between the network device and the collection system prior to sending the collected information.

16. The method of claim 15 in which the signaling phase includes exchanging information relating to transfer and authentication of the collected information sent between the network device and the collection system through a communications channel.

17. The method of claim 16 in which the communications channel comprises a secure connection.

18. The method of claim 1 in which the collected information comprises event logging records.

19. A system comprising:
a collection system coupled to a network device through a communications channel of a computer network system;
a network device collecting information and configured to determine when to send a subset of the collected information to a collection system; and
determine in the network device a subset of the collected information to be transmitted at a given time.

20. The system of claim 19 in which the collected information comprises values stored in counters.

21. The system of claim 20 in which the subset is a value of a counter.

22. The system of claim 20 in which the subset is a value of multiple counters.

23. The system of claim 19 in which the network device is configured to determine when to send a subset of the collected information.

24. The system of claim 19 in which the network device being configured to determine when to send includes the network device being configured to:
determine a low peak period of a network operation; and
send the subset during the low peak period.

25. The system of claim 19 in which the value of the collected information is transmitted with an identifier.
